(19) United States
(12) Patent Application Publication
(10) Pub. No.: US 2009/0042510 A1
(43) Pub. Date: Feb. 12, 2009

(54) APPARATUS AND METHOD OF TRANSMITTING DATA WHILE SCANNING INCUMBENT USER

(75) Inventors: Hyung-Jick LEE, Seongnam-si (KR); Ho-Seok LEE, Anyang-si (KR); Dae-Yong SIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/113,491

(22) Filed: May 1, 2008

(30) Foreign Application Priority Data
Aug. 8, 2007 (KR) 10-2007-0079495

(51) Int. Cl. H04B 7/24

(52) U.S. Cl. 455/39

(57) ABSTRACT

An apparatus and a method of transmitting data while scanning an incumbent user are provided. The method includes dividing each of channels of a frame into sub-channels, and selecting sub-channels to scan the incumbent user among the divided sub-channels.

### CROSS REFERENCE TO RELATED APPLICATION

This application claims priority from Korean Patent Application No. 10-2007-0079495 filed on Aug. 8, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to transmitting data while scanning an incumbent user on a currently-used channel, and more particularly to, transmitting data while scanning an incumbent user in which a used channel is divided into sub-channels, and a portion of the divided sub-channels is set as predetermined sub-channels for scanning the incumbent user, thereby enabling data transmission during scanning of the incumbent user.

2. Description of the Related Art

FIG. 1 illustrates a method of performing fast sensing and fine sensing for scanning an incumbent user in accordance with the IEEE 802.22 standard of a related art. A method of scanning an incumbent user will now be described in detail with reference to FIG. 1. The method of scanning an incumbent user is classified into a fast-sensing method and a fine-sensing method. In the fast-sensing method, when using the IEEE 802.22 standard, an energy level or the like is measured over an entire channel interval per 9 to 20 μs and an incumbent user is scanned. When using a wireless broadband (WiBro) system, an energy level is measured over an entire channel interval per time of 200 μs or more, and an incumbent user is scanned. When it is not possible to know whether an incumbent user exists in a currently-used channel even though fast sensing is performed, fine sensing is further performed. At the time of performing the fine sensing, the corresponding channel is scanned for 24 ms.

According to a related art shown in FIG. 1, data transmission is stopped while fast sensing and fine sensing are performed. A period during which the fast sensing and fine sensing are performed is referred to as a quiet period. If the quiet period is extended, a service interruption period is extended, which deteriorates a QoS (Quality of Service).

Accordingly, a method is required in which even during the quiet period in which the incumbent user is scanned, QoS can be prevented from deteriorating due to the loss of data.

### SUMMARY OF THE INVENTION

The present invention provides an apparatus and a method for transmitting data while scanning an incumbent user, in which a currently-used channel is divided into sub-channels, it is checked whether the incumbent user exists on a selected specific sub-channel, and the data is transmitted through the sub-channels other than the selected specific sub-channel.

The present invention also provides an apparatus and a method of transmitting data while scanning an incumbent user in which each of the sub-channels is divided into carriers, it is checked whether the incumbent user exists on a selected carrier, and the data is transmitted through the carriers other than the selected carrier and the sub-channels.

Aspects of the present invention are not limited to the above description, and other aspects of the present invention will be apparent by those skilled in the art through the following description.

According to an aspect of the invention, there is provided an apparatus for transmitting data while scanning an incumbent user, the apparatus including a dividing module dividing a currently-used channel into sub-channels, and a setting module selecting sub-channels to scan the incumbent user, among the divided sub-channels.

According to another aspect of the invention, there is provided a method of transmitting data while scanning an incumbent user, the method including dividing a transmission channel into sub-channels, and selecting sub-channels to scan the incumbent user among the divided sub-channels.

### BRIEF DESCRIPTION OF THE DRAWINGS

The above and other aspects of the invention will become apparent by describing in detail exemplary embodiments thereof with reference to the attached drawings, in which:

FIG. 1 is a diagram illustrating a method of performing fast sensing and fine sensing to scan an incumbent user in accordance with the IEEE 802.22 standard in a related art;

FIG. 2 is a diagram illustrating a structure of a frame where fast sensing is performed to scan an incumbent user in a sub-channel step according to an exemplary embodiment of the invention;

FIG. 3 is a diagram illustrating a structure of carriers that constitute the sub-channel 208 shown in FIG. 2, according to an exemplary embodiment of the invention;

FIG. 4 is a flowchart illustrating a method of performing fast sensing to scan an incumbent user in a sub-channel step according to an exemplary embodiment of the invention;

FIG. 5 is a flowchart illustrating a method of performing fast sensing to scan an incumbent user in a carrier step according to an exemplary embodiment of the invention;

FIG. 6 is a diagram illustrating an example of a method of performing fine sensing to scan an incumbent user in a sub-channel step according to an exemplary embodiment of the invention;

FIG. 7 is a diagram illustrating a structure of carriers that constitute a sub-channel 604 shown in FIG. 6, according to an exemplary embodiment of the invention;

FIG. 8 is a flowchart illustrating a method of performing fine sensing to scan an incumbent user in a sub-channel step according to an exemplary embodiment of the invention;

FIG. 9 is a flowchart illustrating a method of performing fine sensing to scan an incumbent user at a carrier level according to an exemplary embodiment of the invention;

FIG. 10 is a diagram illustrating instruction words from an SCH (Superframe Control Header) that control the frames shown in FIG. 6, according to an exemplary embodiment of the invention;

FIG. 11 is a diagram illustrating fields of a DCD (Data-link Channel Descriptor) that designate a list of sub-channels or a list of sub-carriers to perform a sensing operation, according to an exemplary embodiment of the invention; and

FIG. 12 is a diagram illustrating a structure of an apparatus for transmitting data while scanning an incumbent user according to an exemplary embodiment of the invention.

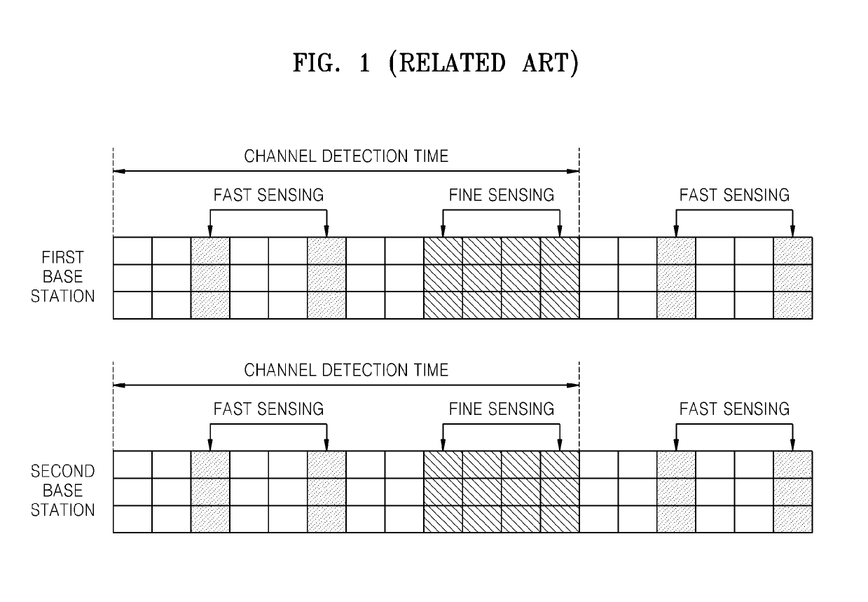

### DETAILED DESCRIPTION OF EXEMPLARY EMBODIMENTS

Aspects of the invention and methods of accomplishing the same may be understood more readily by reference to the following detailed description of exemplary embodiments and the accompanying drawings. The invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the invention will only be defined by the appended claims. Like reference numerals refer to like elements throughout the specification.

Hereinafter, the invention will be described more fully with reference to the accompanying drawings, in which exemplary embodiments of the invention are shown.

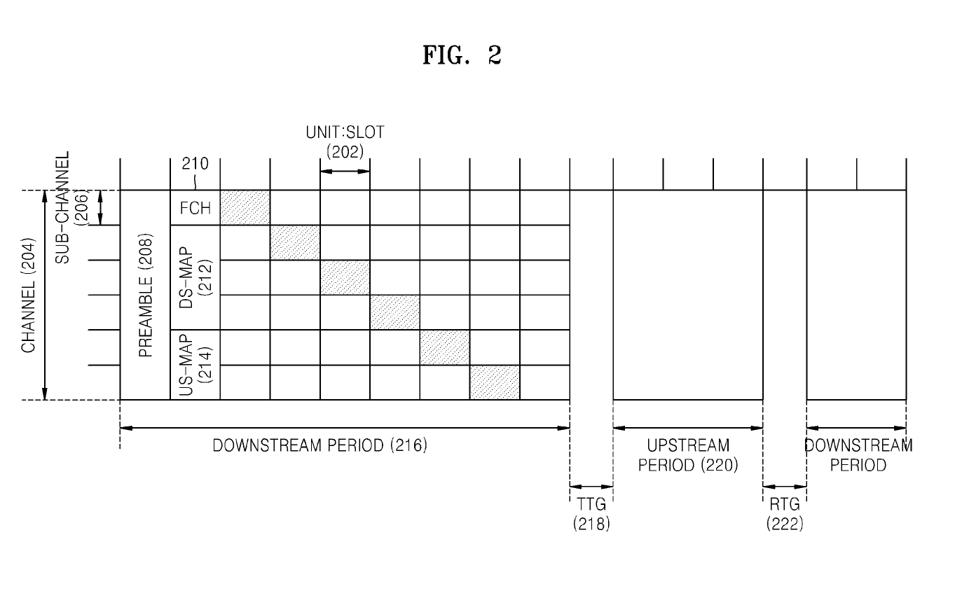

FIG. 2 is a diagram illustrating a structure of a frame where fast sensing is performed to scan an incumbent user in a sub-channel step according to an exemplary embodiment of the invention (here, structures of the frame that are not relevant to the invention are not shown).

Referring to FIG. 2, one frame includes a plurality of slots 202 and a channel 204.

Specifically, the frame has the plurality of slots 202, each of which is a basic unit for transmitting data, and has a unique frequency number. Further, the frame includes the channel 204 that includes a plurality of sub-channels 206.

A preamble 208 is used to synchronize transmission timing between terminals in the channel 204.

A frame control header (FCH) 210 is used to perform channel grouping and channel matching between the channels 204. According to the channel matching, when different channels are used during the downstream period 216 and the upstream period 220, in order to prevent channel identifiers (IDs) during the downstream period 216 and the upstream period 220 from overlapping each other, the downstream period 216 and the upstream period 220 are associated with each other to form a group in a downstream (DS)-MAP 212 and an upstream (US)-MAP 214, and one channel ID is assigned to a group of the downstream period 216 and the upstream period 220 so as to discriminate channels. As a result, a header portion of the frame is decreased and data payload is relatively increased. According to the channel grouping, in the groups of downstream periods 216 and upstream periods 220 that are constructed by the channel matching, terminals having the same matching information are collected. As a result, terminals having the similar band characteristic in cells are collectively managed, thereby efficiently managing the channels.

The DS-MAP 212 allocates data that is transmitted from a base station to terminals. Specifically, the DS-MAP 212 allocates data, which is transmitted to a specific terminal among terminals managed by one base station, to a specific channel, such that the data is transmitted to the specific terminal.

The US-MAP 214 allocates data that is transmitted from terminals to a base station. Specifically, the US-MAP 214 allocates data, which is transmitted to a base station from a specific terminal among terminals managed by one base station, to a specific channel, such that the data is transmitted to the corresponding base station.

A transmitting/receiving transition gap (TTG) 218 indicates a difference between a data transmission time and a data reception time. A receiving/transmitting transition gap) 222 indicates a difference between a data reception time and a data transmission time.

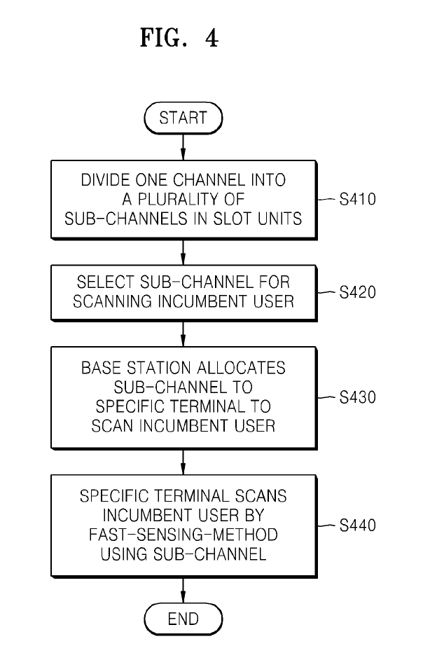

Accordingly, different from the method according to the related art in which an incumbent user is scanned in a unit of the channel 204, an incumbent user is scanned in a unit of each of the sub-channels 206 that are obtained by dividing the channel 204. A method of scanning an incumbent user will be described in detail below with reference to FIGS. 4, 5, 7, and 9.

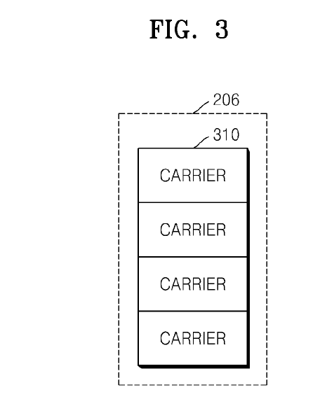

FIG. 3 is a diagram illustrating a structure of carriers that constitute the sub-channel shown in FIG. 2.

Referring to FIG. 3, one sub-channel 206 includes a plurality of carriers 310. When a base station knows characteristics of an incumbent channel user terminal, the base station may be configured such that only carriers through which the characteristics of the incumbent user can be known can be scanned. In this way, it is possible to reduce the amount of time that is needed to scan unnecessary channels. In this case, examples of the incumbent channel user terminal include a digital television (TV), a wireless microphone, and the like.

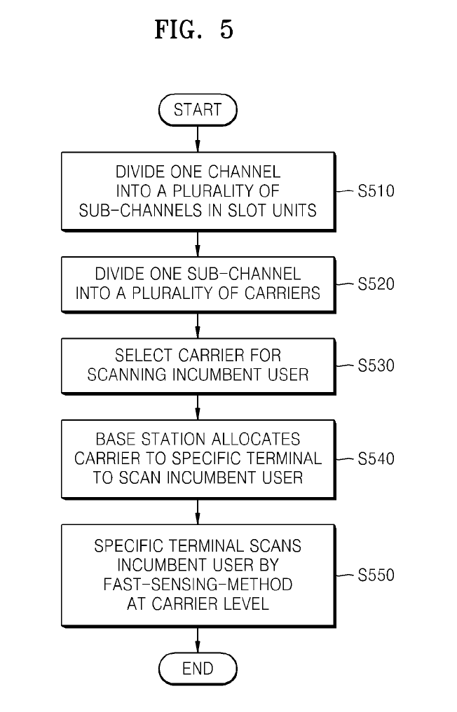

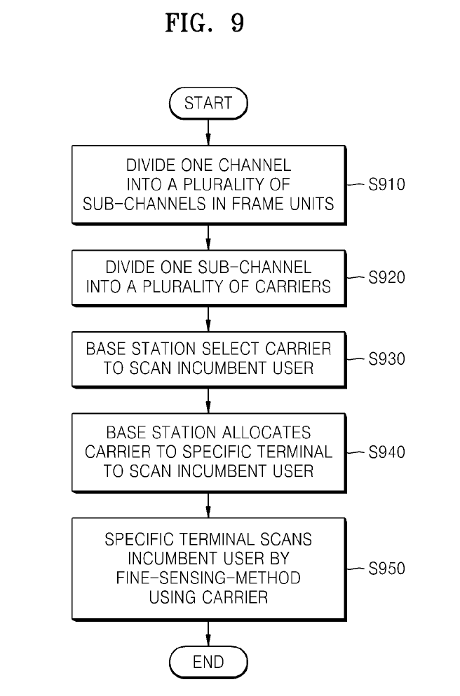

A method of scanning an incumbent user using the carriers 310 will be described in detail below with reference to FIGS. 5 and 9.

FIG. 4 is a flowchart illustrating a method of performing fast sensing to scan an incumbent user in a sub-channel level according to an exemplary embodiment of the invention.

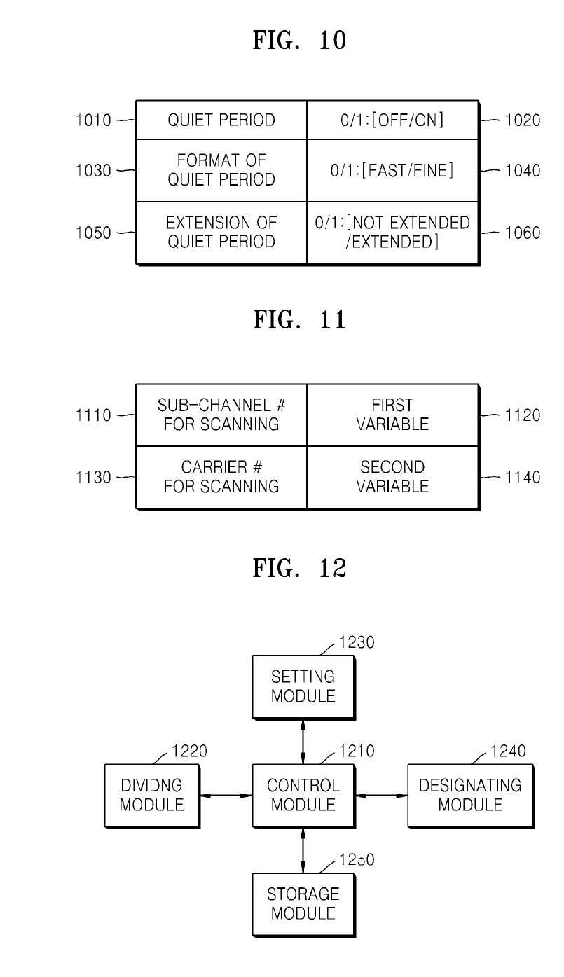

Referring to FIG. 4, one channel is divided into a plurality of sub-channels in a slot unit (S410). The divided sub-channels 206 include sub-channels for transmitting data and sub-channels for scanning an incumbent user. According to instruction words from a superframe control header (SCH), a list of sub-channels for scanning an incumbent user are created in a data link channel descriptor (DCD), which will be described in detail below with reference to FIGS. 10 and 11. The list of sub-channels includes at least one sub-channel. It is preferable, but not necessary, that the sub-channels in the list of sub-channels be not allocated to the same slot 202.

On the basis of the list of sub-channels that is created by the DCD, sub-channels for scanning an incumbent user are selected (S420). If the sub-channels for scanning an incumbent user are selected, the base station allocates the selected sub-channels to a specific terminal to scan an incumbent user (S430), which will be described in detail below with reference to FIGS. 10 and 11.

The base station transmits a frame including data or the like to the specific terminal, and the specific terminal that receives the frame scans an incumbent user. The specific terminal scans an incumbent user by a fast-sensing method at a sub-channel level (S440). In this case, the fast-sensing method is a fast and simple method such as a method of measuring an energy level. The fast-sensing method determines whether an incumbent user exists within a used channel. The specific terminal transmits the result of determination on whether an incumbent user exists in the channel to the base station. As described above with reference to FIG. 2, the sub-channels and carriers for scanning an incumbent user are allocated to the downstream period 216, thereby removing an unnecessary conversion time of transmission (Tx)/reception (Rx). However, the sub-channels and the carriers may be allocated to the upstream period 220.

FIG. 5 is a flowchart illustrating a method of performing fast sensing to scan an incumbent user in a carrier level according to an exemplary embodiment of the invention.

Referring to FIG. 5, one channel is divided into a plurality of sub-channels in a slot unit (S510). The divided sub-channels 208 include sub-channels for transmitting data, sub-channels for scanning an incumbent user, and the like.

Further, one sub-channel is divided into a plurality of carriers (S520). According to the instruction words from the SCH, the DCD creates a list of carriers for scanning an incumbent user, which will be described in detail below with reference to FIGS. 10 and 11. The list of carriers includes at least one carrier. It is preferable, but not necessary, that the plurality of carriers in the list of carriers be not allocated to the same slot 202.

On the basis of the list of carriers that is created by the DCD, the carriers for scanning an incumbent user are selected (S530). If the carriers for scanning an incumbent user are selected, the base station allocates the selected carriers to a specific terminal to scan an incumbent user (S540), which will be described in detail below with reference to FIGS. 10 and 11.

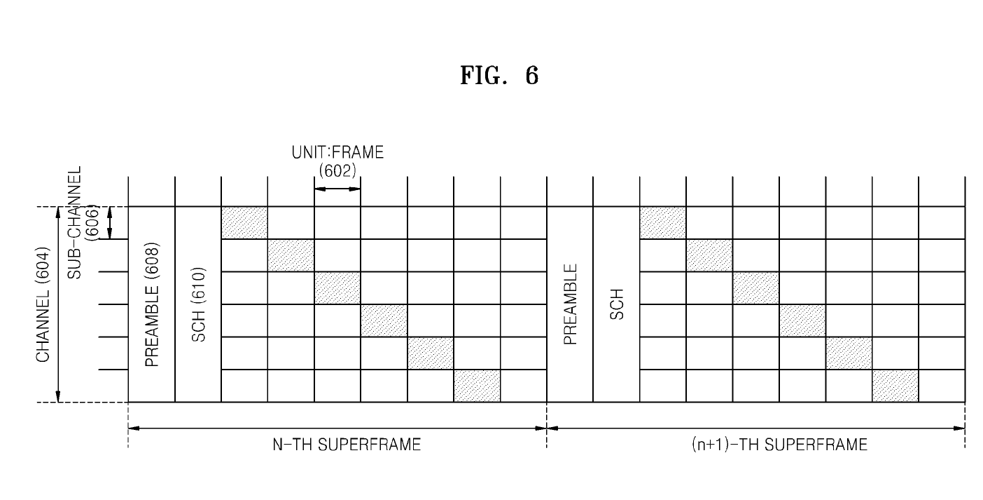

The base station transmits a frame including data or the like to the specific terminal, and the specific terminal that receives the frame scans an incumbent user. The specific terminal scans an incumbent user by a fast-sensing method at a carrier level (S550). In this case, the fast-sensing method is a fast and simple method like the method of measuring an energy level. In the fast-sensing method, an incumbent user is scanned in the channel. If necessary, the base station prepares fine sensing to collect detailed information, which will be described in detail below with reference to FIGS. 6 to 8. Further, when the base station knows the characteristic of the incumbent channel user terminal that uses an incumbent channel, the base station selectively scans only the carriers indicating the characteristic of an incumbent user terminal and determines whether an incumbent user exists. Further, if the channel scan is designated at a carrier level, it is possible to reduce an unnecessary channel-scanning time. In this case, examples of the incumbent channel user terminal include a digital TV, a wireless microphone, and the like.

The specific terminal transmits the result of determination on whether an incumbent user exists in a corresponding channel to the base station. As described above with reference to FIG. 2, the specific terminal allocates sub-channels for scanning an incumbent user to the downstream period 216, and reduces an unnecessary Tx/Rx conversion time. However, the sub-channel may be allocated to the upstream period 222.

FIG. 6 is a diagram illustrating an example of a method of performing fine sensing to scan an incumbent user in a sub-channel level according to an exemplary embodiment of the invention.

Referring to FIG. 6, the functions of the channel 604 and the preamble 608 are the same as described above with reference to FIG. 2.

The frame 602 includes a plurality of slots 202 (shown in FIG. 2), and the slots 202 are discriminated according to time. A superframe includes a plurality of frames 602.

An SCH 610 manages information of a quiet period, the number of frames, power information, location information, and the like.

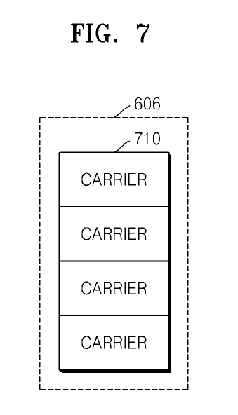

FIG. 7 is a diagram illustrating a structure of carriers that constitute the sub-channel 606 shown in FIG. 6.

Referring to FIG. 7, one sub-channel 606 includes a plurality of carriers 710. When the base station knows the characteristic of the incumbent channel user terminal, the base station can designate the carriers to selectively scan only the carriers indicating the characteristic of an incumbent user terminal. Accordingly, the base station determines whether an incumbent user exists while using the designated carrier 710, which reduces an unnecessary channel scanning time. In this case, examples of the incumbent channel user terminal include a digital TV, a wireless microphone, and the like.

That is, an incumbent user is scanned by using the carriers 710 (a method of scanning carriers is described in detail below with reference to FIG. 9).

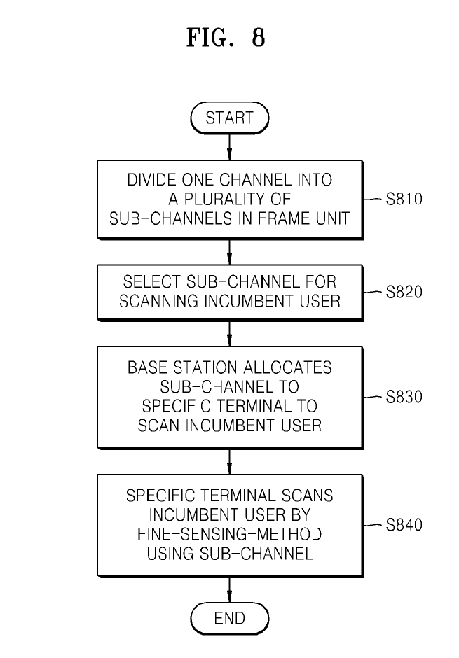

FIG. 8 is a flowchart illustrating a method of performing fine sensing to scan an incumbent user in a sub-channel level according to an exemplary embodiment of the invention.

Referring to FIG. 8, one channel is divided into a plurality of sub-channels in a frame unit (S810). The divided sub-channels 606 include sub-channels for transmitting data and sub-channels for scanning an incumbent user. According to instruction words from the SCH, the DCD creates a list of sub-channels for scanning an incumbent user, which will be described in detail below with reference to FIGS. 10 and 11. The list of sub-channels includes at least one sub-channel. It is preferable, but not necessary, that the sub-channels in the list of sub-channels be not allocated to the same frame 602.

On the basis of the list of sub-channels that is created by the DCD, sub-channels for scanning an incumbent user are selected (S820). If the sub-channels for scanning an incumbent user are selected, the base station allocates the selected sub-channels to a specific terminal to scan an incumbent user using the selected sub-channels (S830), which will be described in detail below with reference to FIGS. 10 and 11.

The base station transmits a frame including data or the like to the specific terminal, and the specific terminal that receives the frame scans an incumbent user. The specific terminal scans an incumbent user by a fast-sensing method using the sub-channel (S840). In this case, when it is not possible to know whether an incumbent user exists or not even though the fast sensing is performed, fine sensing is performed. In the fine sensing, an incumbent user is scanned for 24 ms in a frame unit, and whether an incumbent user exists is precisely determined. The specific terminal transmits the result of determination on whether an incumbent user exists in a channel to the base station. As described above with reference to FIG. 2, the sub-channels for scanning an incumbent user are allocated to the downstream period 216.

FIG. 9 is a flowchart illustrating a method of performing fine sensing to scan an incumbent user at a carrier level according to an exemplary embodiment of the invention.

Referring to FIG. 9, one channel is divided into a plurality of sub-channels in a frame unit (S910). The divided sub-channels 606 include sub-channels to transmit data, sub-channels for scanning an incumbent user, and the like.

Further, one sub-channel is divided into a plurality of carriers (S920). According to instruction words from the SCH, a list of sub-channels for scanning an incumbent user is created in the DCD, which will be described in detail below with reference to FIGS. 10 and 11. The list of carriers includes at least one carrier. It is preferable, but not necessary, that the carriers in the list of carriers be not allocated to the same frame 602.

On the basis of the list of carriers that is created by the DCD, the base station specifies carriers for scanning an incumbent user (S930). When the carriers for scanning an incumbent user are selected, the second variable 1140 of the DCD is used for selecting the carriers through which a specific terminal scans an incumbent user, which will be described in detail below with reference to FIGS. 10 and 11. Subsequently, the base station allocates the selected carriers to a specific terminal to scan an incumbent user (S940).

The base station transmits a frame including data or the like to the specific terminal, and the specific terminal that receives the frame scans an incumbent user. The specific terminal scans an incumbent user by a fine-sensing method using the carriers (S950). In this case, when it is not possible to know whether an incumbent user exists in the channel is not reliable even though the fast sensing is performed, the fine sensing is performed. In the fine sensing, whether an incumbent user exists is precisely determined for 24 ms in a frame unit. When the base station knows the characteristic of the incumbent channel user terminal, it is possible to scan an incumbent user with ease and fast. In this case, examples of the incumbent channel user terminal include a digital TV, a wireless microphone, and the like.

The specific terminal transmits the result of determination on whether the incumbent user uses a channel to the base station. As described above with reference to FIG. 2, the target sub-channels for scanning an incumbent user are allocated to the downstream period 216. However, the target sub-channels may be allocated to the upstream period 220.

FIG. 10 is a diagram illustrating instruction words from an SCH that control frames shown in FIG. 6.

Referring to FIG. 10, an SCH 610 determines whether to set a quiet period 1010 or not. In this case, the quiet period 1010 corresponds to a period during which a data exchange between a base station and a terminal is stopped while the terminal scans an incumbent user.

As shown in FIG. 10, when the quiet period 1010 is to be set, “1:On” 1020 is written, and when the quiet period 1010 is not to be set, “0:Off” 1020 is written.

When the SCH 610 sets the quiet period 1010, a format of the quiet period 1030 sets fast sensing or fine sensing 1040. In the case of the fast sensing, “0” 1040 is written, and in the case of the fine sensing, “1” 1040 is written.

When a sensing operation is not completely performed in a frame or slot unit after the quiet period 1010 is set by the SCH 612, the quiet period 1050 needs to be extended. The extension of the quiet period 1050 means that a frame or slot is additionally allocated. When the frame or slot is not to be additionally allocated, “0” 1060 is written, and when the frame or slot is to be additionally allocated, “1” 1060 is written.

FIG. 11 is a chart illustrating fields of a DCD that designates a list of sub-channel or a list of carriers.

Referring to FIG. 11, the DCD that receives the instruction words from the SCH has a list of sub-channels or a list of carriers to allow the specific terminal to scan an incumbent user using a specific sub-channel or a specific carrier, as described above with reference to FIG. 10.

As shown in FIG. 10, the list of sub-channels has the following format.

The “Sub-Channel # to Scan” 1110 means that a specific sub-channel corresponds to a sub-channel for scanning an incumbent user. The first variable 1120 has a format of “Channel #, Sub-Channel #, CPE ID”. Accordingly, the first variable 1120 has the meaning of a specific terminal scanning an incumbent user in a specific sub-channel of a specific channel.

The “Carrier # to Scan” 1130 means a carrier that is designated for scanning an incumbent user, and the second variable 1140 has a format of “Channel #, Carrier #, CPE ID”. The second variable 1140 has the meaning of the specific terminal scanning an incumbent user in the specific carrier of the specific channel.

Further, the list of sub-channels and the list of carriers are changed per constant time or according to the change in ambient environment and the setting of the user. The specific terminal determines whether an incumbent user exists by using the list of sub-channels and the list of carriers that have been updated.

Accordingly, the SCH determines whether the fast sensing is to be performed or the fine sensing is to be performed, and whether the additional slot or frame is needed when performing a sensing operation is allocated. According to the determination of the SCH, the specific terminal performs a scanning operation to check whether an incumbent user exists by using the list of sub-channels or the list of carriers that are stored in the DCD.

FIG. 12 is a diagram illustrating a structure of an apparatus for transmitting data while scanning an incumbent user according to an exemplary embodiment of the invention (in this case, constituent elements that are not relevant to the invention are not shown).

Referring to FIG. 12, an apparatus for transmitting data while scanning an incumbent user (hereinafter, referred to as “apparatus”) includes a control module 1210, a dividing module 1220, a setting module 1230, a designating module 1240, and a storage module 1250.

The dividing module 1220 performs the following functions.

The dividing module 1220 divides a channel of a frame into a plurality of sub-channels. The dividing module 1220 divides one sub-channel into a plurality of carriers. The dividing module 1220 divides one frame into a plurality of slots.

With respect to the sub-channels, the carriers, and the slots that have been divided in the above-described methods, and the frame, the setting module 1230 performs the following functions.

First, the setting module 1230 selects sub-channels for scanning an incumbent user based on the divided sub-channels and the divided slots. In this case, at least one of the divided sub-channels and the divided slots can be used to scan the incumbent user.

Second, the setting module 1230 selects sub-channels for scanning an incumbent user based on the divided sub-channels and the frame. In this case, at least one of the divided sub-channels and the frame can be used to scan the incumbent user.

Third, the setting module 1230 selects carriers for scanning an incumbent user based on the divided carriers and the frame. In this case, at least one of the divided carriers and the frame can be used to san the incumbent user.

Fourth, the setting module 1230 selects carriers for scanning an incumbent user based on the divided carriers and slots. In this case, at least one of the divided carriers and the divided slots can be used to san the incumbent user.

Fifth, the setting module 1230 can set sub-channels or carriers to transmit data.

With respect to the sub-channels, the carriers, and the slots that have been divided in the above-described methods, and the frame, the designating module 1240 performs the following functions.

First, the designating module 1240 allocates a specific terminal to scan an incumbent user based on the divided sub-channels and the divided slots. In this case, the designating module 1240 can allocate the specific terminal to at least one of the divided sub-channels and the divided slots.

Second, the designating module 1240 allocates a specific terminal to scan an incumbent user based on the divided sub-channels and the frame. In this case, the designating module 1240 can allocate the specific terminal to at least one of the divided sub-channels and the frame.

Third, the designating module 1240 allocates a specific terminal to scan an incumbent user based on the divided carriers and the frame. In this case, the designating module 1240 can allocate the specific terminal to at least one of the divided carriers and the frame.

Fourth, the designating module 1240 allocates the specific terminal to scan an incumbent user based on the divided carriers and the divided slots. In this case, the designating module 1240 can allocate the specific terminal to at least one of the divided carriers and the divided slots.

The storage module 1250 stores the list of channels, the list of sub-channels, and the list of carriers that are used for the selection by the setting module 1230, as described above.

The control module 1210 scans a channel using the list of channels, the list of sub-channels, and the list of carriers that are stored in the storage module 1250, as described above, and manages and controls the apparatus. Specifically, the control module 1210 performs the following functions.

First, the control module 1210 allocates the scanning sub-channels and scanning carriers selected by the setting module 1230 to frames during a downstream period or an upstream period. In particular, the scanning sub-channels or scanning carriers, which are selected for determining whether an incumbent user exists, may be allocated to the downstream period.

Second, the control module 1210 manages and controls a superframe or a frame using at least one of the list of channels, the list of sub-channels, and the list of carriers by the setting module 1230.

Third, the control module 1210 performs a control operation such that an incumbent user is scanned through the selected scanning sub-channels and scanning carriers.

While the invention has been described with reference to the accompanying drawings, it will be understood by those skilled in the art that various modifications, changes and substitutions of the invention can be made without departing from the spirit and scope of the invention as defined by the following claims. Therefore, it is to be understood that the above-described exemplary embodiments are just illustrative examples and the invention is not limited to the above-described exemplary embodiments. The invention will be defined by the appended claims to be described below, rather than the disclosure. It should be understood that the invention is intended to cover meanings of the scope of the claims and various modifications and changes deduced from the equal concept.

The apparatus and method of transmitting data while scanning an incumbent user according to the exemplary embodiments of the inventions can achieve the following effects.

The currently-used channel is divided into sub-channels, and the incumbent user is scanned. As a result, since the data can be transmitted through the sub-channels other than the designated channel, the data transmission can be prevented from being delayed, and the data can be transmitted even during the quiet period.

Further, since the incumbent user is only scanned in the specific carrier among the divided carriers, it is unnecessary to scan the incumbent user in the carriers other than the specific carrier, which leads to improvement in the data transmission efficiency.

What is claimed is:

1. An apparatus for transmitting data while scanning an incumbent user, comprising:
a dividing module that divides a channel into sub-channels; and
a setting module that selects at least one scanning sub-channel for scanning the incumbent user, among the sub-channels.

2. The apparatus of claim 1, further comprising a control module that allocates the at least one scanning sub-channel to at least one frame corresponding to a downstream period or upstream period.

3. The apparatus of claim 1, wherein the dividing module divides at least one of the sub-channels into carriers.

4. The apparatus of claim 1, wherein the dividing module divides a frame into slots according to time.

5. The apparatus of claim 1, further comprising a designating module that allocates a terminal to scan the incumbent user to the selected at least one scanning sub-channel.

6. A method of transmitting data while scanning an incumbent user, comprising:
dividing a channel into sub-channels; and
selecting at least one scanning sub-channel for scanning the incumbent user among the sub-channels.

7. The method of claim 6, further comprising setting a scanning period for the scanning the incumbent user.

8. The method of claim 7, wherein, in the setting the scanning period, the scanning period is extended in a unit of a frame or a superframe.

9. The method of claim 6, further comprising scanning the incumbent user using the at least one scanning sub-channel.

10. The method of claim 6, wherein the dividing the channel into the sub-channels comprises dividing a frame into slots according to time.

11. The method of claim 10, wherein the selecting the at least one scanning sub-channel is performed in a unit of a slot of the slots.

12. The method of claim 6, wherein the selecting the at least one scanning sub-channel comprises allocating the at least one scanning sub-channel to at least one frame according to a given condition comprising at least one of time, ambient environment and user setting.

13. The method of claim 6, further comprising designating a terminal to scan the incumbent user to the at least one scanning sub-channel.

14. The method of claim 6, further comprising creating a list of sub-channels for scanning the incumbent user.

15. The method of claim 14, further comprising updating the list of sub-channels according to a given condition comprising at least one of time, ambient environment and user setting.

16. The method of claim 6, further comprising:
dividing at least one of the sub-channels into carriers; and
selecting at least one scanning carrier for scanning the incumbent user among the carriers.

17. The method of claim 16, further comprising scanning the incumbent user using the at least one scanning carrier.

18. The method of claim 17, wherein the scanning the incumbent user is performed using information on a characteristic of the incumbent user.

19. The method of claim 16, further comprising, for scanning the incumbent user, selecting at least one of the at least one scanning sub-channel and the at least one scanning carrier.

20. The method of claim 16, wherein the dividing the at least one of the sub-channels into the carriers comprises dividing a frame into slots according to time.

21. The method of claim 20, wherein the selecting the at least one scanning carrier is performed in a unit of a slot of the slots.

22. The method of claim 16, wherein the selecting the at least one scanning carrier comprises allocating the at least one scanning carrier to a frame according to a given condition comprising at least one of time, ambient environment and user setting.

23. The method of claim 16, further comprising designating a terminal to scan the incumbent user to the at least one scanning carrier.

24. The method of claim 16, further comprising creating a list of carriers for scanning the incumbent user.

25. The method of claim 24, further comprising updating the list of carriers according to a given condition comprising at least one of time, ambient environment and user setting.
